(19) United States
(12) Patent Application Publication
(10) Pub. No.: US 2022/0159758 A1
(43) Pub. Date: May 19, 2022

(54) Apparatuses and Methods for Data Duplication

(71) Applicant: Nokia Technologies OY, Espoo (FI)

(72) Inventors: Daniela LASELVA, Klarup (DK); David NAVRATIL, Helsinki (FI)

(21) Appl. No.: 17/310,958

(22) PCT Filed: Mar. 4, 2019
(86) PCT No.: PCT/EP2019/055315

§ 371 Date: Sep. 2, 2021

(51) Int. Cl. H04W 76/15

(52) U.S. Cl. CPC H04W 76/15

(57) ABSTRACT

Apparatuses and methods for data duplication are disclosed. Information on one or more user terminals are received by an apparatus from a base station serving the one or more user terminals located in a same host unit. Received information is compared to information of the user terminals the apparatus is serving. Based on the comparison, it is determined that at least some of the one or more user terminals served by the apparatus are located in the same host; and the at least some of the one or more user terminals are scheduled to utilize different radio resources that provide largest frequency or time diversity available between the at least some of the one or more user terminal.

### TECHNICAL FIELD

The exemplary and non-limiting embodiments of the invention relate generally to communications.

### BACKGROUND

Wireless telecommunication systems are under constant development. There is a constant need for higher data rates and high quality of service. Reliability requirements are constantly rising and ways and means to ensure reliable connections and data traffic while keeping transmission delays minimal are constantly under development.

One possibility to increase reliability is to increase path redundancy, and thus path independence, in any network domain, including the user terminal or device. This leads also to increase availability in addition to reliability in an end-to-end fashion. One of the key scenarios where creating path redundancy is beneficial is for Time Sensitive Networks, TSN, which are defined and operated according to multiple standards comprising IETF Deterministic Networks (DetNet) and Wireless Industrial Ethernet (IEEE 802.1 TSN standard), where IETF denotes Internet Engineering Task Force and IEEE Institute of Electrical and Electronics Engineers.

Some of the possible solution to increase reliability and availability are higher layer duplication (where the duplication is controlled in the core network or outside the 3GPP network, e.g. at the application server), or radio level duplication (where duplication is controlled by the RAN, e.g. at the Packet Data Convergence Protocol, PDCP, level). The co-existence of these solutions introduces problems as they operate independently.

### BRIEF DESCRIPTION

According to an aspect of the present invention, there are provided apparatuses of claims 1 and 9.

According to an aspect of the present invention, there are provided methods of claims 18 and 25.

One or more examples of implementations are set forth in more detail in the accompanying drawings and the description below. Other features will be apparent from the description and drawings, and from the claims.

### BRIEF DESCRIPTION OF THE DRAWINGS

In the following the invention will be described in greater detail by means of preferred embodiments with reference to the accompanying drawings, in which

FIG. 1 illustrates a general architecture of an exemplary communication system;

FIG. 2 illustrates an example of Time sensitive network realization in connection with a 5G network;

FIGS. 3A and 3B illustrate examples of higher layer duplication;

FIGS. 4A and 4B are flowcharts illustrating some embodiments of the invention;

FIG. 5 illustrates an example of a combination of higher layer duplication with Dual Connectivity operation for data duplication; and

FIGS. 6 and 7 illustrate examples of apparatuses employing some embodiments of the invention.

### DETAILED DESCRIPTION OF SOME EMBODIMENTS

In the following, different exemplifying embodiments will be described using, as an example of an access architecture to which the embodiments may be applied, a radio access architecture based on long term evolution advanced (LTE Advanced, LTE-A), enhanced LTE (eLTE), or new radio (NR, 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

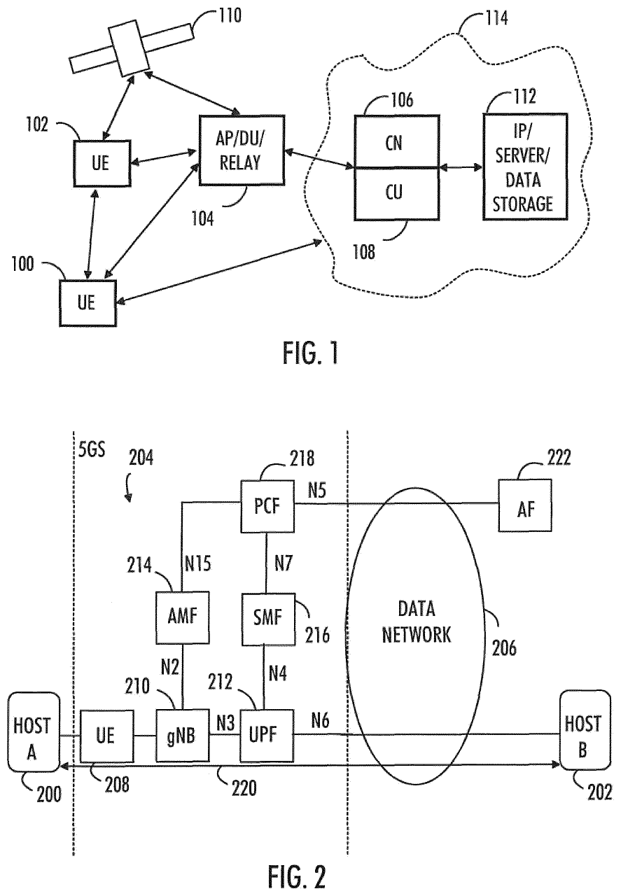

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for data and signaling purposes. The (e/g)NodeB is a computing device configured to control the radio resources of communication system it is coupled to. The (e/g)NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 106 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. One technology in the above network may be denoted as narrowband Internet of Things (NB-Iot). The user device may also be a device having capability to operate utilizing enhanced machine-type communication (eMTC). The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, perhaps more base stations or nodes than the LTE (a so-called small cell concept), including macro sites operating in co-operation with smaller stations and employing a variety of radio technologies depending on service needs, use cases and/or spectrum available. 5G mobile communications support a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, above 6 GHz-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and mobile edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloud RAN architecture enables RAN real time functions being carried out at the RAN side (in a distributed unit, DU 104) and non-real time functions being carried out in a centralized manner (in a centralized unit, CU 108).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

In an embodiment, 5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 110 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

As mentioned, radio access network may be split into two logical entities called Central Unit (CU) and Distributed Unit (DU). In prior art, both CU and DU supplied by the same vendor. Thus, they are designed together and interworking between the units is easy. The interface between CU and DU is currently being standardized by 3GPP and it is denoted F1 interface. Therefore, in the future the network operators may have the flexibility to choose different vendors for CU and DU. Different vendors can provide different failure and recovery characteristics for the units. If the failure and recovery scenarios of the units are not handled in a coordinated manner, it will result in inconsistent states in the CU and DU (which may lead to subsequent call failures, for example). Thus there is a need to enable the CU and DU from different vendors to coordinate operation to handle failure conditions and recovery, taking into account the potential differences in resiliency capabilities between the CU and DU.

In some cases reliability of connections is very important. These kind of connections may relate to Internet of Things (IoT), for example. For these cases adding redundancy to connections has been brought up. One possibility to add redundancy and reliability is Time-sensitive-network (TSN), which is a IEEE 802.1 standard, whose interworking with the 5GS (5G system) is illustrated in FIG. 2. IEEE stands for Institute of Electrical and Electronics Engineers. The 5GS can act as a link or a bridge that operates according to guaranteed and promised capabilities in terms of guaranteed latency and delay variations of the user plane.

FIG. 2 illustrates an example where two hosts 200, 202 are communicating with each other via 5G network 204 and a data network 206. In this example Host A 200 comprises or is connected to user terminal 208. The user terminal is connected to a base station or gNB 210 which provides the user terminal a connection to data network 206 via one or more User Plane Functions 212 The user terminal is further connected to Core Access and Mobility Management Function, AMF 214, which is a control plane core connector for (radio) access network and can be seen from this perspective as the 5G version of Mobility Management Entity, MME, in LTE. The 5G network further comprises Session Management Function, SMF 216, which is responsible for subscriber sessions, such as session establishment, modify and release and a Policy Control Function 218 which is configured to govern network behavior by providing policy rules to control plane functions.

A TSN solution comprises five main components, TSN flow, End devices, bridges, Central network controller, CNC, and Centralized user configuration, CUC.

TSN flow denotes the time-critical communication between end devices, in the example of FIG. 2 communication 220 between Host A 200 and Host B 202. Each flow has strict time requirements that the networking devices honor. Each TSN flow is uniquely identified by the network devices by means of unique identifiers (such as destination Multiple Access Channel, MAC address, Virtual Local Area Network, VLAN, for example).

End devices are the source and destinations of the TSN flows. The end devices are running an application that requires deterministic communication. These are also referred to as talkers and listeners.

Bridges can also be referred as Ethernet switches. For TSN, these are special bridges capable of transmitting the Ethernet frames of a TSN flow on a schedule and receiving Ethernet frames of a TSN flow according to a schedule.

Central network controller, CNC, acts as a proxy for the network (the TSN Bridges and their interconnections) and the control applications that require deterministic communication. The CNC defines the schedule on which all TSN frames are transmitted.

Centralized user configuration, CUC, is an application that communicates with the CNC and the end devices. The CUC represents the control applications and the end devices. The CUC makes requests to the CNC for deterministic communication (TSN flows) with specific requirements for those flows.

The CNC is configured to communicate with the CUC to receive the communications requirements that the network must provide. The CNC aggregates all the requests, computes the route for each communication request, schedules the end-to-end transmission for each TSN flow, and finally transfers the computed schedule to each TSN bridge.

In the example of FIG. 2, an Application Function, AF, connected to PCF 218 may correspond to the Central network controller, CNC 222.

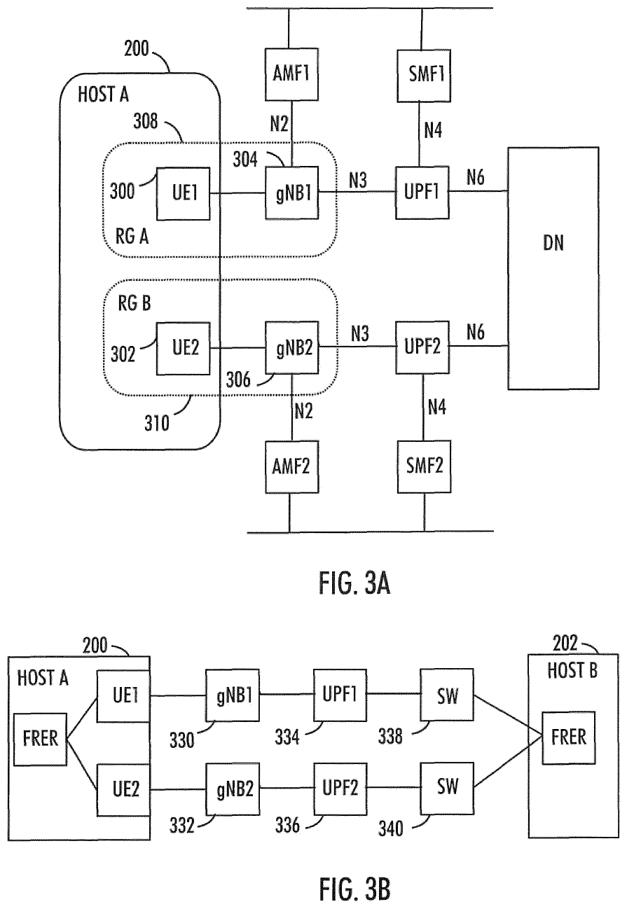

To increase reliability, it has been proposed to use packet duplication or redundancy in communication. FIG. 3A illustrates an example of higher layer duplication. In the example of FIG. 3A, a host in a device 200 comprises multiple user terminals 300, 302 (e.g. host multi-homed) which may be configured to connect to different gNBs 304, 306 independently. Radio access network coverage is redundant in the target area: it is possible to connect to multiple gNBs from the same location. This example makes use of the integration of multiple user terminals into the same host/device.

To ensure that the two user terminals connect to different gNBs, the gNBs need to operate such that the selection of gNBs can be distinct from each other (such as gNBs operating in different frequencies etc.). For the gNB selection it has been proposed to define Reliability Groups (RG) parameter for the user terminals and also for the cells of gNBs. By grouping the user terminals in the device and cells of gNBs in the network into more than one reliability group and preferably selecting cells in the same reliability group as the user terminal, it is ensured that user terminals in the same host can be assigned different gNBs for redundancy, as shown in FIG. 3A where the user terminal 300 and the cells of gNB1 belong to reliability group A 308, and the user terminal 302 and the cells of gNB2 belong to reliability group B 310.

FIG. 3B illustrates an example of a schematic of higher layer duplication solution where host A has two user terminals which use independent radio access network (gNB) and Core Network (UPF) entities.

A first Packet Data Unit, PDU, Session spans from the UE1 via gNB1 330 to UPF1 334, while the second PDU Session spans from the UE2 via gNB2 332 to UPF2 336. Based on these two independent PDU Sessions, two independent paths may be set up, which may span even beyond the 3GPP network. In the example shown in FIG. 3B, there are two paths set up between Host A and Host B, with some fixed intermediate nodes 338, 340. A Redundancy Handling Function, RHF, entities that reside in Host A and Host B are configured to make use of the independent paths. In the example of FIG. 3B, Host A and Host B comprise a Frame Replication and Elimination for Reliability, FRER, unit which is an example for an RHF entity, according to the IEEE TSN standard. For Host A, the two user terminals provide different networking interfaces, making the host redundantly connected. Note that in the network side, other solutions are also possible, where redundancy spans only up to an intermediate node and not to the end-host.

To obtain further redundancy and reliability in communication, it is possible to utilize Dual Connectivity. In an embodiment, a Packet Data Convergence Protocol, PDCP, entity which duplicates PDCP PDUs has two associated Radio Link Control, RLC, entities, one located in the same node, such as a master node and the other one, located in a secondary node, which nodes are connected with each other via a Xn/X2 interface, for example, i.e. Dual Connectivity, DC, based PDCP duplication. It is noted that the nodes operating in DC may be of the same radio access technology, e.g. NR, NR-NR DC, or differ, e.g. E-UTRAN-NR DC. In another embodiment, the PDCP entity which duplicates PDCP PDUs has two associated RLC entities, which are both located in the same node, i.e. Carrier Aggregation, CA, based PDCP duplication. For this, there is in place the restriction that the two RLC entities (associated to the PDCP entity), cannot be mapped to the same component carrier (CC) to prevent vanishing of the diversity gain.

Combination of higher layer duplication and PDCP duplication (either in conjunction with CA or DC) provides significant improvement in reliability. However, there are difficulties related to scheduling the PDU sessions in such a manner that the links carrying the sessions are as uncorrelated as possible to obtain diversity gain.

The proposed solution enables the network entities identify that two or more of its RLC entities are associated with user terminals which belong to the same host, and consequently apply rules to restrict the scheduling of the identified RLC entities with the aim of increasing transmission diversity.

In the proposed solution, the task is first to identify the RLC entities involved, i.e. determined the connections of user terminals which are located in the same host. Second, the task is to schedule the connections associated to the identified entities. The purpose of scheduling is to increase diversity, or make the connections as “orthogonal” as possible.

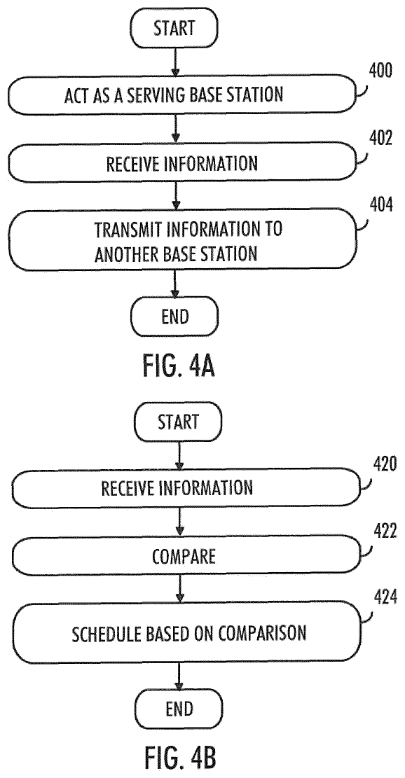

FIGS. 4A and 4B are flowcharts illustrating some embodiments of the invention. FIGS. 4A and 4B illustrate examples of the operation of an apparatus or a network element configured to operate as base station or gNB or a part of a base station. In an embodiment, FIG. 4A illustrates the operation of a Master gNB in Dual Connectivity.

In step 400 of FIG. 4A, the apparatus is configured to act as a serving base station to one of user terminals located in a same host unit. The user terminals may utilize Time-Sensitive Network, TSN. In an embodiment, the apparatus may be a master base station MgNB and Dual Connectivity or PDCP based duplication may be initialized.

In step 402 of FIG. 4A, the apparatus is configured to receive information on one or more user terminals located in a same host unit.

In step 404 of FIG. 4A, the apparatus is configured to transmit information on the one or more user terminals to a base station serving a user terminal of the one or more user terminals located in a same host unit. In an embodiment, the base station acts as a secondary base station SgNB and the transmission occurs when setting up dual connectivity.

Moving to FIG. 4B, in step 420 of FIG. 4B, the apparatus is configured to receive, from a base station serving a user terminal of one or more user terminals located in the same host, information on the one or more user terminals located in the same host, In an embodiment, the information is received from a MgNB when setting up one of the one or more user terminals to dual connectivity, the user terminals utilizing Time-Sensitive Network, TSN.

In step 422 of FIG. 4B, the apparatus is configured to compare received information to information of the user terminals the apparatus is serving.

In step 424 of FIG. 4B, the apparatus is configured to, based on the comparison, determine that at least some of the one or more user terminals are located in a same host and schedule the at least some of the one or more user terminals to utilize different radio resources that provide largest frequency or time diversity available between the at least some of the one or more user terminals.

In an embodiment, the information received in step 402 may be the identifier of the one or more terminals located in the same host unit, wherein the identifier of the one or more terminals is one of a Time-Sensitive Network identifier, one or more Multiple Access Channel, MAC, addresses of the host, Radio Access Network, RAN, temporary identifier, temporary or global identifier.

In an embodiment, the information transmitted in step 404 and received in step 420 may comprise information about the time-frequency resources used for the user equipment at the MgNB.

Let us study some examples of different embodiments related to above steps.

In an embodiment, the apparatus is configured to receive, from the network the apparatus is serving, one or more Multiple Access Channel, MAC, addresses of the host where user terminal is located. In an embodiment, user terminal in the host has indicated to the gNB/AMF via signalling the MAC address or addresses of the host. All user terminals serving the same host will report the same MAC addresses and this way the connection between the terminals can be detected. in other words, the user terminals can be “paired”.

Here, the one or more MAC addresses are the destination MAC address as in the TSN frame terminated to the host. In an embodiment, a table of paired user terminals is maintained in core at AMF or other network function (such as SMF). This information (MAC address) can be provided to Radio Access Network for example during RAN context establishment of a given user terminal.

Then, the apparatus may be configured to transmit, to a base station acting as a secondary base station SgNB, the MAC address or addresses of the host when setting up Dual Connectivity for the user terminal the base station acts as a master base station MgNB. This transmission may be done when setting up Xn connection between the base stations during SgNB addition/reconfiguration, for example.

The apparatus acting as a secondary base station may be configured to receive, from the base station acting as a master base station, one or more Multiple Access Channel, MAC, addresses of a host to which a user terminal is connected when setting up the user terminal to dual connectivity.

Then, the apparatus may be configured further to determine whether there a user terminals served by the apparatus that have the same MAC address, and based on the comparison, schedule such user terminals. In other words, in case, there exist already RLC entities at the SgNB for any of the indicated paired user terminals (i.e. terminals associated to the same MAC addresses), the SgNB will flag them for scheduling, as those RLC entities are terminated at the same host.

In an embodiment, the apparatus of FIG. 4A receives, from the user terminal the base station acts as a master base station MgNB, Radio Access Network temporary identifiers of the one or more other user terminals. For example, the user terminal may indicate to the gNB the 5G-S-TMSI of other UEs in the host, where TMSI denotes Temporary Mobile Subscriber Identity. The MgNB further transmits, to a base station acting as a secondary base station SgMB, the Radio Access Network temporary identifiers of the one or more other user terminals when setting up Dual Connectivity for the user terminal the base station acts as a master base station. This transmission may be done when setting up Xn connection between the base stations during SgNB addition/reconfiguration, for example.

A 5G-S-TMSI identifies a user terminal uniquely only within a tracking area. This introduces a constrain that all cells should in the same area. This alternative may be feasible for factory deployments, for example. A benefit over the first example is that the identification of the paired user terminals relies on 5G native identifiers rather than on TSN identifiers.

Regarding SgNB apparatus, it is configured to receive, from the base station acting as a MgNB, Radio Access Network temporary identifiers of one or more user terminals when setting up one of the one or more user terminals to dual connectivity, determine whether there are user terminals served by the SgNB that have the received Radio Access Network temporary identifiers, and based on the comparison, schedule such user terminals.

In an embodiment, the apparatus acting as MgNB is configured to receive, from the user terminal the base station acts as a MgNB, permanent or temporary global identifiers of the one or more other user terminals.

This may happen during user terminal context setup, for example.

The user terminal may indicate a permanent identifier SUbscription Permanent Identifier, SUPI, SUbscription Concealed Identifier SUCI, 5G Globally Unique Temporary User Terminal Identity 5G-GUTI or permanent equipment identifiers (PEI) (i.e. International Mobile Station Equipment Identity IMEI or International Mobile Station Equipment Identity and Software Version number IMEISV). If 5G-GUTI is used, then the user terminal should indicate the change to gNB when it receives a new 5G-GUTI, such that the pairing procedure is performed each time the 5G-GUTI changes.

The MgNB transmits to SgNB the permanent identifiers of the one or more other user terminals when setting up Dual Connectivity. This transmission may be done when setting up Xn connection between the base stations during SgNB addition/reconfiguration, for example.

Regarding SgNB apparatus, it is configured to receive from MgNB permanent identifiers of the one or more other user terminals when setting up one of the one or more user terminals to dual connectivity, determine whether there a user terminals served by the apparatus that have the received permanent identifiers, and based on the comparison, schedule such user terminals.

In an embodiment, the apparatus acting as MgNB is configured to receive, from the network the base station is serving, information on the Multiple Access Channel, MAC, addresses associated with Packet Data Unit sessions established to a same data network. the transmission may come from Core Network, for example UPF, via SMF and AMF.

The MgNB may transmit to SgNB the MAC address of a user terminal when setting up Dual Connectivity for the user terminal. This transmission may be done when setting up Xn connection between the base stations during SgNB addition/reconfiguration, for example.

The SgNB may be configured to receive from MgNB a MAC address or addresses of a host to which a user terminal is connected when setting up the user terminal to dual connectivity. Then, the SgNB may be configured further to determine whether there is a user terminal served by the apparatus that have the same MAC address, and based on the comparison, schedule such user terminals. In other words, in case, there exist already RLC entities at the SgNB for any of the indicated paired user terminals (i.e. terminals associated to the same MAC address), the SgNB will flag them for scheduling, as those RLC entities are terminated at the same host.

In an embodiment, the apparatus acting as MgNB is configured to determine the Reliability Group parameter of the user terminal the base station acts as a master base station. in other words, the MgNB identifies the RLC entities which are associated to different Reliability Groups and which may be terminated at the same host. The Reliability Group parameter is as provided by the AMF during RAN context establishment.

The MgNB transmits to the SgNB the Reliability Group parameter of the user terminal when setting up Dual Connectivity for the user terminal. This transmission may be done when setting up Xn connection between the base stations during SgNB addition/reconfiguration, for example.

Regarding SgNB apparatus, it is configured to receive from MgNB the Reliability Group parameter of a user terminal when setting up Dual Connectivity for the user terminal, determine if there are user terminals served by the apparatus having different Reliability Group parameter and, based on the comparison, schedule such user terminals. This is a very simple alternative, although it may introduce unnecessary restrictions in case a gNB has RLC entities with reliability Groups that are not terminated to the same host. Some unnecessary scheduling may occur.

In an embodiment, the apparatus acting as MgNB is configured to receive, from the network the apparatus is serving, information on a policy identifier which indicates the existence of Packet Data Unit sessions established from a same host; and transmit to SgNB the user plane restriction identifier when setting up Dual Connectivity for a user terminal.

In an embodiment, the AF 222, which in some embodiments may be also a user terminal, requests a creation of a new policy (for example by invoking a Npcf_PolicyAuthorization_Create request) that indicates that PDU sessions are used for user plane data duplication. The PDU sessions can be identified by MAC addresses used by user terminals. PCF is configured to identify impacted PDU sessions, decide on the policy and allocate a unique identifier for the policy, for example a user plane scheduling restriction identifier. Alternatively, global identities (SUPI, PEI) and PDU session IDs could be used instead of the user plane scheduling restriction identifier. PCF is configured to notify the serving SMFs of the impacted PDU sessions about the policy update.

The notification from PCF triggers SMF to initiate PDU session update for each impacted PDU sessions. The PDU sessions are updated with the policy identifier or user plane scheduling restriction identifier. The gNB is configured to store the policy identifier or the user plane scheduling restriction identifier for each PDU session.

Regarding SgNB apparatus, it is configured to receive from MgNB information on a policy identifier or user plane scheduling restriction identifier which indicates the existence of Packet Data Unit sessions established from a same host, determine if there are user terminals served by the apparatus having the same policy identifier and, based on the comparison, schedule such user terminals.

Let us study some examples of different embodiments related to scheduling performed by the SgNB apparatus.

In an embodiment, scheduling may comprise determining if there are multiple component carriers, CC, available, and, based on the determination, schedule the one or more user terminals to different component carriers.

In an embodiment, scheduling may comprise scheduling the one or more user terminals to bandwidth parts, BWPs, that provide largest frequency diversity within the available bandwidth. In an embodiment, paired user terminals (i.e. terminals in the same host) are configured with “orthogonal” BWPs in both UL and DL, such that the frequency resources of those BWPs are placed as farther apart as possible to achieve the largest frequency diversity within the same system bandwidth. In an embodiment, the MgNB and SgNB may signal with each other with regard to BWP selection.

In an embodiment, scheduling may comprise scheduling the one or more user terminals to apply mutually orthogonal discontinuous transmission, DRX, cycles. The paired user terminals (i.e. terminals in the same host) are configured with orthogonal DRX, where the active times are as orthogonal as possible to achieve time diversity. To achieve this, the MgNB and SgNB may be configured to exchange and/or negotiate the DRX cycle of paired UEs.

In an embodiment, scheduling may comprise determining a scheduling offset based on channel variability in time and applying the scheduling offset to the transmissions of the one or more user terminals. In an embodiment, the longer time correlation the longer offset is selected. As a non-limiting numerical example, time correlation of 10 TTI/slots may lead to scheduling offset larger than 10 TTI/slots.

In an embodiment, a scheduling algorithm may be applied in such a manner, that is multiple component carriers are available, then scheduling is based on those. If not, then if “orthogonal” BWPs are available they are used. If not, then if “orthogonal” DRX resources are available, they are used. If not, then scheduling offset solution is applied.

The proposed method allows to achieve the largest degree of diversity or independency between the PDU sessions terminated to user terminals in the same host. Benefit from higher layer and PDCP duplication is obtained and various failure points in the end-to-end paths may be efficiently handled.

The proposed solution is applicable in both uplink and downlink directions, i.e. both directions may be scheduled according to above described embodiments.

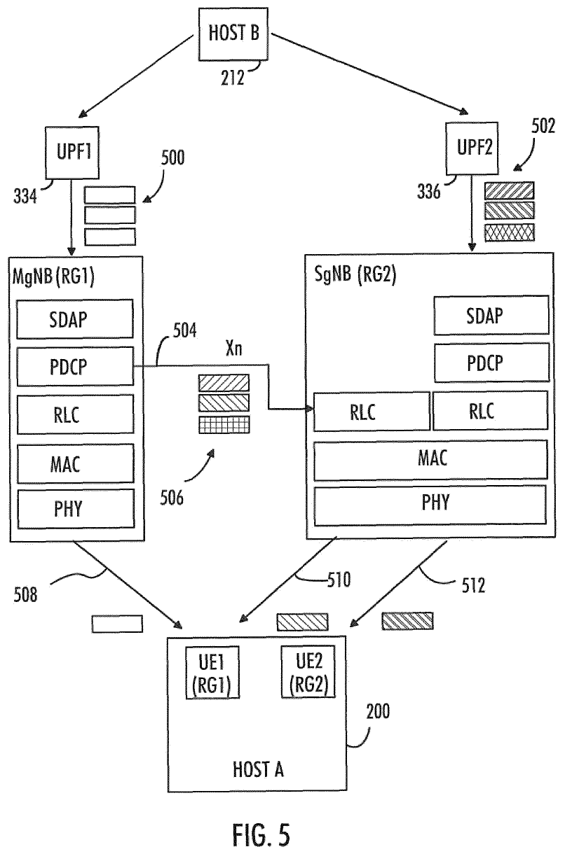

FIG. 5 illustrates an example of an embodiment. Host B 212 is communicating with Host A 200. Both higher level duplication and PDCP Dual Connectivity as utilized. Host B transmit packets to UPF1 334 and UPF2 336. UPF1 forwards packets 500 to MgNB 330, which is in Reliability Group 1 and UPF2 forwards packets 502 to SgNB 332, which is in Reliability Group 2.

MgNB 330 receives information on one or more user terminals located in Host A. As described above, the information may be MAC Address of the Host A or some other information such as temporary or global or permanent identifiers of user terminals or a policy identifier, for example.

When setting up Dual Connectivity or Xn connection 504 between the MgNB and SgNB or during SgNB addition/reconfiguration, MgNB transmits the information to SgNB.

SgNB receives the information, compares received information to information of the user terminals the apparatus is serving and based on the comparison, schedules at least some of the one or more user terminals as described above.

SgNB receives Dual Connectivity packets 506 from MgNB. MgNB transmits 508 packets to the Hos A and SgNB's transmissions 510, 512 are scheduled to be as orthogonal as possible.

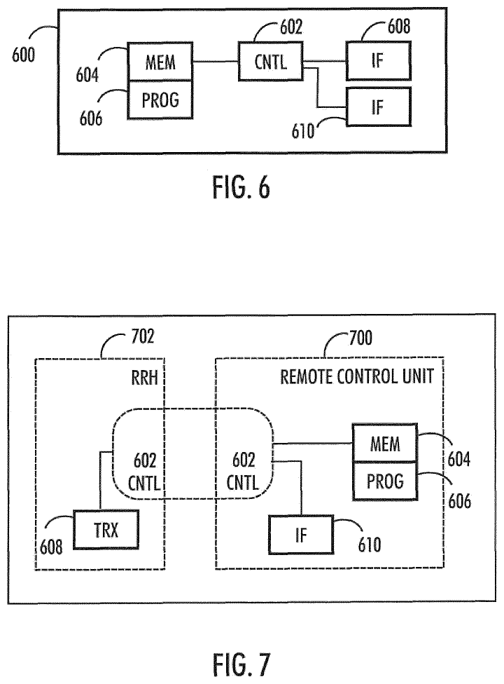

FIG. 6 illustrates an embodiment. The figure illustrates a simplified example of an apparatus applying embodiments of the invention. In some embodiments, the apparatus may be a base station (gNB) or a part of a base station, or any other entity of the communication system provided that the necessary inputs are available and required interfaces exists to transmit and receive required information.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus 600 of the example includes a control circuitry 602 configured to control at least part of the operation of the apparatus.

The apparatus may comprise a memory 604 for storing data. Furthermore the memory may store software 606 executable by the control circuitry 602. The memory may be integrated in the control circuitry.

The apparatus may comprise one or more interface circuitries 608, 610. If the apparatus is a base station or a part of a base station one of the interfaces may be a transceiver 608 configured to communicate wirelessly with user terminals. The transceiver may be connected to an antenna arrangement (not shown). Other interface(s) 610 may connect the apparatus to other network elements of the communication system. The interface may provide a wired or wireless connection to the communication system. The interfaces may be operationally connected to the control circuitry 602.

The software 606 may comprise a computer program comprising program code means adapted to cause the control circuitry 602 of the apparatus to perform the embodiments described above and in the claims.

In an embodiment, as shown in FIG. 7, at least some of the functionalities of the apparatus of FIG. 6 may be shared between two physically separate devices, forming one operational entity. Therefore, the apparatus may be seen to depict the operational entity comprising one or more physically separate devices for executing at least some of the described processes. Thus, the apparatus of FIG. 7, utilizing such shared architecture, may comprise a remote control unit RCU 700, such as a host computer or a server computer, operatively coupled (e.g. via a wireless or wired network) to a remote radio head RRH 702 located in the base station. In an embodiment, at least some of the described processes may be performed by the RCU 700. In an embodiment, the execution of at least some of the described processes may be shared among the RRH 702 and the RCU 700.

In an embodiment, the RCU 700 may generate a virtual network through which the RCU 700 communicates with the RRH 702. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (e.g. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RRH and the RCU. In practice, any digital signal processing task may be performed in either the RRH or the RCU and the boundary where the responsibility is shifted between the RRH and the RCU may be selected according to implementation.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, which may comprise a working memory (RAM), a central processing unit (CPU), and a system clock. The CPU may comprise a set of registers, an arithmetic logic unit, and a controller. The controller is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

In an embodiment, the apparatus comprises means for acting as a serving base station to one of user terminals located in a same host unit; means for receiving information on the one or more user terminals located in the same host unit; and means for transmitting the information on the one or more user terminals located in the same host unit to a base station serving a user terminal of the one or more user terminals.

In an embodiment, the apparatus comprises means for receiving, from a base station serving one or more user terminals located in a same host unit, information on one or more user terminals, means for comparing received information to information of the user terminals the apparatus is serving; means for, based on the comparison, determining that at least some of the one or more user terminals served by the apparatus are located in the same host; and means for scheduling the at least some of the one or more user terminals to utilize different radio resources that provide largest frequency or time diversity available between the at least some of the one or more user terminals.

It will be obvious to a person skilled in the art that, as the technology advances, the inventive concept can be implemented in various ways. The invention and its embodiments are not limited to the examples described above but may vary within the scope of the claims.

1. An apparatus comprising
at least one processor;
at least one non-transitory memory including computer program code;
the at least one memory and the computer program code configured to, with the at least one processor, cause the apparatus at least to perform:
act as a serving base station to one of user terminals located in a same host unit;
receive information on the one or more user terminals located in the same host unit;
transmit the information on the one or more user terminals located in the same host unit to a base station serving a user terminal of the one or more user terminals.

2. The apparatus of claim 1, the at least one memory and the computer program code configured to, with the at least one processor, cause the apparatus further to perform:
receive the identifier of the one or more terminals located in the same host unit.

3. The apparatus of claim 2, wherein the identifier of the one or more terminals is one of:
a time-sensitive network identifier,
one or more multiple access channel addresses of the host,
a radio access network temporary identifier, or
a temporary or global identifier.

4. The apparatus of claim 1, the at least one memory and the computer program code configured to, with the at least one processor, cause the apparatus further to perform:
act as a master base station to one of the user terminals located in the same host unit; and
transmit the information on the one or more user terminals to a base station acting as a secondary base station when setting up dual connectivity for the user terminal the base station acts as a master base station.

5. The apparatus of claim 1, wherein the apparatus is configured to receive the information on the one or more user terminals from one of the user terminals.

6. The apparatus of claim 1, the at least one memory and the computer program code configured to, with the at least one processor, cause the apparatus further to perform:
receive, from the network the apparatus is serving, information on the multiple access channel addresses associated with packet data unit sessions established to a same data network; and
transmit, to the base station serving a user terminal of the one or more user terminals, the multiple access channel address of the user terminal.

7. The apparatus of claim 1, the at least one memory and the computer program code configured to, with the at least one processor, cause the apparatus further to perform:
determine the reliability group parameter of the user terminal of the one or more user terminals the apparatus is serving;
transmit, to the base station serving a user terminal of the one or more user terminals, the reliability group parameter of the user terminal.

8. The apparatus of claim 1, the at least one memory and the computer program code configured to, with the at least one processor, cause the apparatus further to perform:
receive, from the network the apparatus is serving, information on a policy identifier which indicates the existence of packet data unit sessions established from a same host; and
transmit, to the base station serving a user terminal of the one or more user terminals, the policy identifier.

9. An apparatus comprising
at least one processor;
at least one non-transitory memory including computer program code;
the at least one memory and the computer program code configured to, with the at least one processor, cause the apparatus at least to perform:
receive, from a base station serving one or more user terminals located in a same host unit, information on one or more user terminals,
compare received information to information of the user terminals the apparatus is serving;
based on the comparison, determine that at least some of the one or more user terminals served by the apparatus are located in the same host; and
schedule the at least some of the one or more user terminals to utilize different radio resources that provide largest frequency or time diversity available between the at least some of the one or more user terminals.

10. The apparatus of claim 9, wherein the information received from the base station serving one or more user terminals located in a same host unit is one of:
a time-sensitive network identifier,
a multiple access channel address,
a radio access network temporary identifier, or
a temporary or global identifier.

11. The apparatus of claim 9, the at least one memory and the computer program code configured to, with the at least one processor, cause the apparatus further to perform:
receive, from a base station serving one or more user terminals located in a same host unit, the reliability group parameter of a user terminal;
determine if there are user terminals served by the apparatus having the different reliability group parameter;
based on the comparison, schedule such user terminals.

12. The apparatus of claim 9, the at least one memory and the computer program code configured to, with the at least one processor, cause the apparatus further to perform:
receive, from a base station serving one or more user terminals located in a same host unit, information on a policy identifier which indicates the existence of packet data unit sessions established from a same host; and
determine if there are user terminals served by the apparatus having the same policy identifier;
based on the comparison, schedule such user terminals.

13. The apparatus of claim 9, wherein the information received from the base station serving one or more user terminals located in a same host unit comprises information about the time-frequency resources used for the user equipment at the base station serving one or more user terminals located in a same host unit.

14. The apparatus of claim 9, the at least one memory and the computer program code configured to, with the at least one processor, cause the apparatus further to perform:
determine if there are multiple component carriers available,
based on the determination, schedule the one or more user terminals to different component carriers.

15. The apparatus of claim 9, the at least one memory and the computer program code configured to, with the at least one processor, cause the apparatus further to perform:
schedule the one or more user terminals to bandwidth parts that provide largest frequency diversity within the available bandwidth.

16. The apparatus of claim 9, the at least one memory and the computer program code configured to, with the at least one processor, cause the apparatus further to perform:
schedule the one or more user terminals to apply mutually orthogonal discontinuous transmission cycles.

17. The apparatus of claim 9, the at least one memory and the computer program code configured to, with the at least one processor, cause the apparatus further to perform:
determine a scheduling offset based on channel variability in time;
apply the scheduling offset to the transmissions of the one or more user terminals.

18. A method in a communication system, comprising:
act as a serving base station to one of user terminals located in a same host unit;
receive information on the one or more user terminals located in the same host unit;
transmit the information on the one or more user terminals located in the same host unit to a base station serving a user terminal of the one or more user terminals.

19.-24. (canceled)

25. A method in a communication system, the method comprising:
receive, from a base station serving one or more user terminals located in a same host unit, information on one or more user terminals,
compare received information to information of the user terminals the apparatus is serving;
based on the comparison, determine that at least some of the one or more user terminals served by the apparatus are located in the same host; and
schedule the at least some of the one or more user terminals to utilize different radio resources that provide largest frequency or time diversity available between the at least some of the one or more user terminals.

26.-33. (canceled)

34. A non-transitory computer readable medium storing a computer program comprising instructions for causing an apparatus of a communication system to perform any of the method steps of claim 18.

35. A non-transitory computer readable medium storing a computer program comprising instructions for causing an apparatus of a communication system to perform the method steps of claim 25.
